(19) United States
(12) Patent Application Publication
(10) Pub. No.: US 2014/0183227 A1
(43) Pub. Date: Jul. 3, 2014

(54) LIQUID DISPENSING DEVICE ESPECIALLY FOR BEVERAGES

(71) Applicant: Francesca Barnini, Lastra A Signa (FI) (IT)

(72) Inventor: Francesca Barnini, Lastra A Signa (FI) (IT)

(21) Appl. No.: 14/233,271

(22) PCT Filed: Jul. 16, 2012
(86) PCT No.: PCT/IB2012/053622

§ 371 Date: Jan. 16, 2014

(30) Foreign Application Priority Data
Jul. 16, 2011 (IT) PO2011A000015

(51) Int. Cl. B67D 1/08; B65D 83/00

(52) U.S. Cl. CPC B67D 1/04
USPC 222/152; 222/400.7

(57) ABSTRACT

A device (1) for dispensing liquids, particularly wine, from a bottle or similar container includes a body (2) designed to work with the neck (27) of the bottle and to cause the leakage of the liquid from a blowpipe (10) resulting from the supply in the bottle of an inert gas (eg. nitrogen) under pressure. Said body (2) comprises a first conduit (3), placed transversely and with a first opening (22) for the supply of the gas. Two further openings (20 and 21) are placed along the conduit (3) for connecting them with a second conduit (4) designed to supply the gas inside the bottle and, respectively, with a third conduit (5) provided with a blowpipe (10) for dispensing the liquid.

### TECHNICAL FIELD

The present invention relates to a device for dispensing liquids from bottles or similar containers. In particular the invention relates to a device for dispensing beverages such as wine.

### PRIOR ART

Devices of this kind are described in EP1352873, WO2009125310, WO2010052681 and WO2010055057.

A known problem in beverage dispensing devices, especially of wine, is given by the settlement of residues of the beverage inside the device at the end of each dispensing.

A further known problem is given by the difficulty of replacing quickly and easily the empty bottle with a new full one, without causing any contamination of the device.

The proposed solutions to the above mentioned device problems are relatively complex resulting among other things, after each dispensing, with insufflations within the device of the inert gas used for the delivery of the liquid (wine) or a second gas under pressure.

Moreover, in this way the cleaning of the blowpipe, where the liquid comes out, is obtained but not the cleaning of the internal conduits of the device.

Furthermore, the known devices, being generally assembled on bases or pedestals or on a support frame of the bottle, don't allow to perform an adequate and complete cleaning of the blowpipe nozzle and of the internal conduits at the time of the replacement of an empty bottle with a new full one.

### DISCLOSURE OF THE INVENTION

The main purpose of the present invention is therefore to provide a device for dispensing liquids, especially wine, in which the cleaning of the blowpipe nozzle and of the internal conduits take place automatically at the end of each dispensing without the need to blow gas.

A further purpose of the invention is to provide a device which allows to quickly and easily replace an empty bottle with a new full one and that it can be completely immersed in water for its cleaning

From the following description of a non-limiting example of implementation, it will be evident the further purposes and advantages of the invention.

### BRIEF DESCRIPTION OF THE DRAWINGS

In the drawings:

FIG. 1 illustrates a sectional view of a device in accordance to the invention;

FIGS. 2 and 3 show enlarged partial sectional views of the device in two operating steps;

FIGS. 4 and 5 show the way of application of the device to the neck of a bottle.

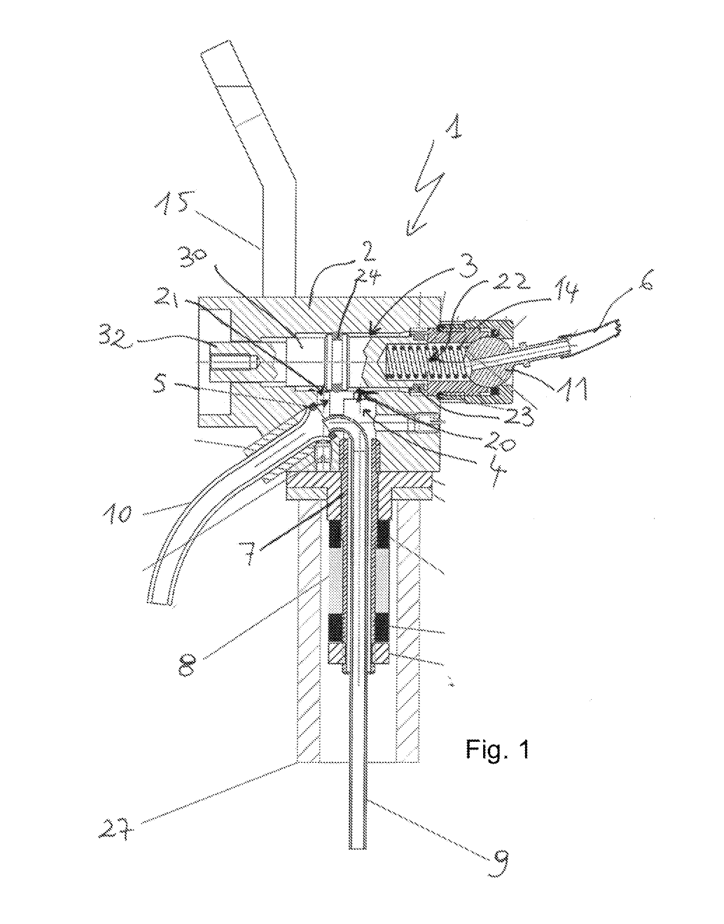

### PREFERRED EMBODIMENT OF THE INVENTION

With reference to the attached images, a device 1 for dispensing liquids, especially wine, from a bottle or a similar container is composed of a body 2 designed to work with the neck 27 of the bottle and to cause the leakage of liquid from a blowpipe 10 resulting from the supply of inert gas (eg. nitrogen) under pressure.

Said body 2 is composed of a first conduit 3, that is placed transversely and has a first opening 22 for the supply of the gas. It has two further openings 20 and 21, that are placed along the conduit 3 for the connection with a second conduit 4 designed to supply the gas inside the bottle and it has a third conduit 5 provided with a blowpipe 10 for the dispensing of the liquid.

More specifically, said second conduit 4 protrudes from the body 2 through a first tube 7 intended to settle inside the neck 27 of the bottle. A second tube 9 is advantageously placed culminating on the upper part of the supply blowpipe 10, passing through said first tube 7 and it extends downward inside the bottle.

A movable cursor 30 within said conduit 3 is subject to the action of a helical spring 14 attested between one of its ends and an articulated nipple 11, mounted to the opening 22 and provided for the coupling of the supply conduit of the gas 6. When the spring 14 is not loaded, the end 32 of the cursor 30 opposite to that subject to the spring partially protrudes from the opening of the conduit 3 opposite the opening 22. As will become apparent from the hereinafter, the cursor 30 performs the functions of operating button of the dispensing device.

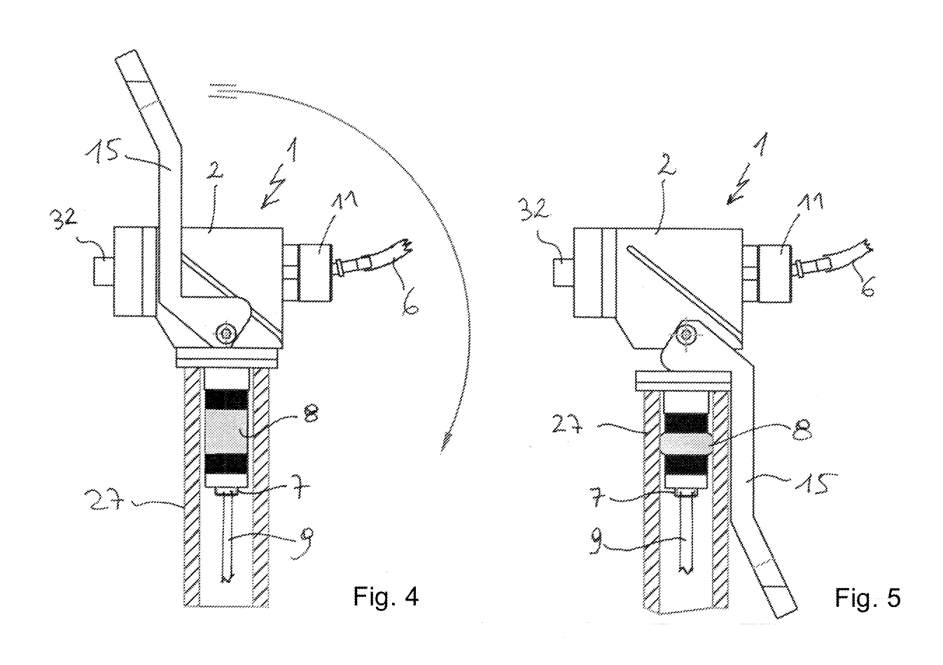

The sealed connection of the device 1 with the neck of the bottle 27 is preferably made (see FIGS. 4 and 5) with an expansion system 8, associated with said first tube 7 and controlled by a lever 15.

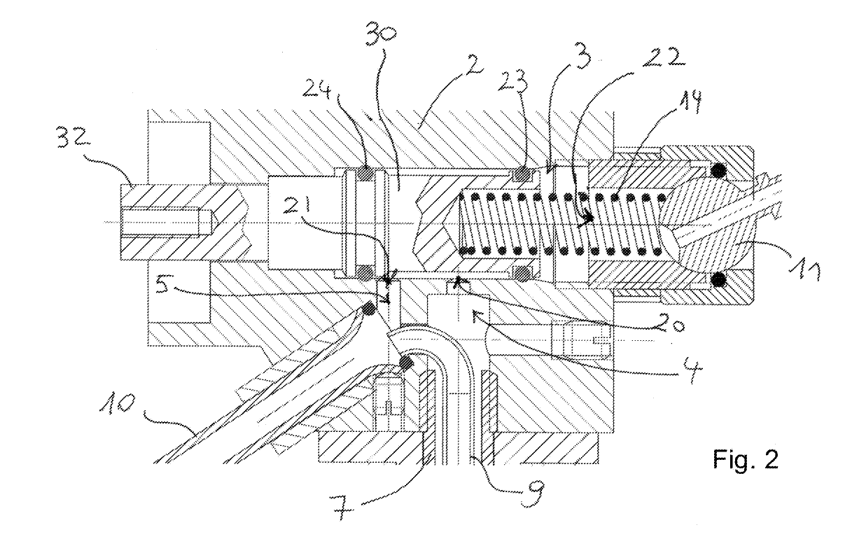

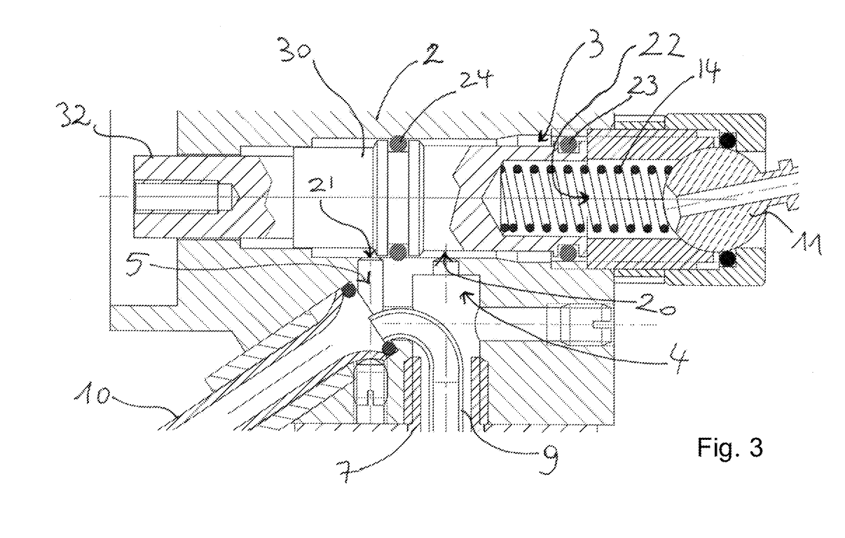

In accordance with the invention and as illustrated in FIGS. 2 and 3, the conduit 3 and the cursor 30 are shaped so as to selectively put in communication:

i) said second conduit 4 with the opening 22 in order to cause the release of the gas in the bottle and dispensing of the liquid and

ii) said second conduit 4 with said third conduit 5 in order to determine the leakage of gas through the blowpipe 10 at the end of dispensing.

In a preferred embodiment of the invention, the cursor 30 is provided with a pair of O-rings 23.24 of which the first (23) is substantially placed at the end of the cursor on the side of the opening 22 of the gas inlet and is located, with reference to the flow of gas injected, always upstream of the openings 20 and 21. The second O-ring 24 is instead located at a distance from the first one so that, in the rest position (see FIG. 2), is located downstream of both openings 20 and 21, while when the cursor 30 is pushed against the spring 14 assumes a position between the two openings (see FIG. 3).

The inner diameter of the duct 3 is such that, in the rest position, the O-rings 23.24 isolate from the gas the part of conduit in which the openings 20 and 21 are placed. During the dispensing phase, (ie, when the cursor-button 30 is pressed), since the diameter of the pipe 3 is greater in correspondence to the opening 22, only the O-ring 24 which is located between the openings 20 and 21 carries the support functions.

The functioning of the device is as follows:

a) in the resting phase (see FIG. 2), the gas—fed at the opening 22 by means of the articulated nipple 11—is confined upstream of the O-ring 23 placed at the end of the cursor 30; the second conduit 4 and the third conduit 5 are in communication with each other via the openings 20 and 21 and the light existing between the outer surface of the cursor 30 and the inner surface of the conduit 3; there is no gas flow nor pressure is exerted to inside of the bottle and, accordingly, no conduit of the device is wetted by the liquid—as happens for example in the device described in EP1352873—except obviously for the portion of the tube 9 which enters into it;

b) in the loading phase, when the cursor 30 is pushed towards the opening 22 (see FIG. 3), the support of the O-ring 23 is less and the gas penetrates inside the conduit 3 along the outer surface of the cursor 30; the O-ring 24 has moved between the two openings 20,21 maintaining the support, the gas flows through the opening 20, flows into the second conduit 4 and from here is put, through the first tube 7, in the bottle; the pressure exerted by the gas determines the leakage of liquid through the second tube 9 and the blowpipe 10;

c) in the discharge phase, when at the end of the supply the delivery cursor-button 30 is released, the two O-rings 23,24 return to assume the positions at which isolate the gas from the conduit portion in which there are the openings 20 and 21 (see FIG. 2); therefore the placing of the gas and consequently the supply of the liquid ceases; the gas contained in the bottle flows first through the pipe 7, the second conduit 4 and the opening 20 in the opposite direction with respect to the loading phase, and then along the portion of the pipe 3 between the openings 20 and 21, then through the third conduit 5 and the blowpipe 10; the liquid in the tube 9 falls inside the bottle and, thanks to a particular conformation of the upper end portion, protrudes along the blowpipe 10.

Note that, thanks to the operation described above, the device object of the present invention offers considerable advantages in terms of cleaning of the conduits.

In fact, the outflow of the gas during discharge through the blowpipe 10 determines the complete cleaning of the same from the residues of the beverage without the need to blow in another gas.

In addition to this, the vacuum generated by the emptying of the conduit 9—due to the relapse of the liquid inside the bottle—causes the suction of part of the inert gas coming out of the third conduit 5, without that the air can penetrate from the blowpipe 10. Therefore, it is also obtained that also the conduit 9 is completely cleaned of residues and there is no risk of oxidation of the liquid.

An empty bottle can also be easily and quickly replaced with a full new one by using the control lever 15 of the expansion system 8. Since in the resting phase the internal conduits are not filled by the liquid, once disengaged from the neck of the bottle, the device can be completely immersed in a washing bath.

The example described is given by way of example, but it is understood that equivalent variants can be conceived without departing from the scope of the invention.

1. A device for delivering liquid from a bottle or similar container, the device comprising:
a body adapted to engage with a neck of the bottle and to cause fluid to exit from a dispensing spout following an injection into the bottle of in an inert gas under pressure, said body including a first channel, which extends across said body and said body has a first opening for introduction of the gas, wherein two further openings are provided spaced along said first conduit to put in communication with a second channel adapted to enter the gas inside the bottle and, respectively, with a third channel leading to the dispensing spout.

2. A device according to claim 1, wherein said second channel leaves the body via a first tube intended to settle in the neck of the bottle, wherein a second tube is provided which leads above to the dispensing spout, said second tube extending through said first tube and said second tube extending below inside the bottle.

3. A device according to claim 1, wherein a cursor having a sealing means is provided at the first opening of said first channel and said cursor is movable between a first position in which said second channel is placed in communication with said first opening in order to cause the injection of the gas into the bottle and dispensing of liquid, and a second position in which said second channel is placed in communication with said third channel to cause the exit of the gas through the dispensing spout at an end of dispensing.

4. A device according to claim 1, wherein said body is mounted on a support and said body is provided with a quick release means for dismounting from the support in case of maintenance and cleaning.

5. A device according to claim 2, wherein a cursor having a sealing means is provided at the first opening of said first channel and said cursor is movable between a first position in which said second channel is placed in communication with said first opening in order to cause the injection of the gas into the bottle and dispensing of liquid, and a second position in which said second channel is placed in communication with said third channel to cause the exit of the gas through the dispensing spout at an end of dispensing.

6. A device according to claim 2, wherein said body is mounted on a support and said body is provided with a quick release means for dismounting from the support in case of maintenance and cleaning.

7. A device according to claim 3, wherein said body is mounted on a support and said body is provided with a quick release means for dismounting from the support in case of maintenance and cleaning.

8. A device according to claim 5, wherein said body is mounted on a support and said body is provided with a quick release means for dismounting from the support in case of maintenance and cleaning.
